(19) United States
(12) Patent Application Publication
(10) Pub. No.: US 2005/0244616 A1
(43) Pub. Date: Nov. 3, 2005

(54) Magnetic ornamental refrigerator border strip

(76) Inventors: Rodney John Meadows, Marion, IA (US); Cheryl Ann Meadows, Marion, IA (US)

Correspondence Address: RODNEY J. MEADOWS, 5705 WINSLOW RD., MARION, IA, 52302, US

(21) Appl. No.: 10/836,948

(22) Filed: May 3, 2004

(51) Int. Cl. B32B 23/02

(52) U.S. Cl. 428/192

(57) ABSTRACT

This is a magnetic strip having a decoratively embossed, painted, printed or veneered, outside or face surface, and used primarily to adorn the front and or sides of a refrigerator, stove or any similar surface that will support the function of a magnet.

### BACKGROUND OF THE INVENTION

1. Field of the Invention

This invention relates to the field of a magnetic border strip used for cosmetic purposes to adorn or beautify any surface that will support the function of a magnet.

2. Description of Prior Art

Prior art deals predominantly with ornamental and sometimes cartoonish magnets primarily serving the purpose of holding notes, pictures and the like to a refrigerator or other observable location that will support the function of a magnet. My invention is to be used mainly to assist the user with better color or design flow within the area of use.

### SUMMARY OF THE INVENTION

This invention is a “Magnetic Ornamental Refrigerator Border Strip” used to beautify the front and/or sides of the typical refrigerator, stove or other similar surface that will support the function of a magnet. It is made from extremely thin magnetic sheet material and is cut into strips of various lengths and widths. The outer or front surface of each strip will receive a finish by the methods of embossing, painting, printing, veneering or overlaying a color and decorative design or material.

The intent of this invention is to make available to the end user, a ready to use, simple to install decorative strip designed to enhance the appearance of any item that will support the function of a magnet such as, but not limited to a refrigerator door or stove front.

### DRAWINGS

### BRIEF DESCRIPTION OF THE DRAWINGS

The drawings included are meant only to show a few of the many ways our invention can be used. The following descriptions are for better clarity.

### DETAILED DESCRIPTION OF THE DRAWINGS

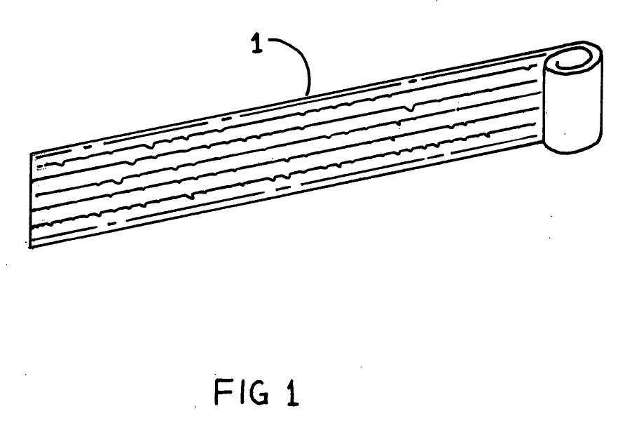

FIG. 1

Is an isometric view showing the partially rolled single strip of decorative magnetic strip (1), depicting a design on the surface as it would appear prior to being cut to length and put into place.

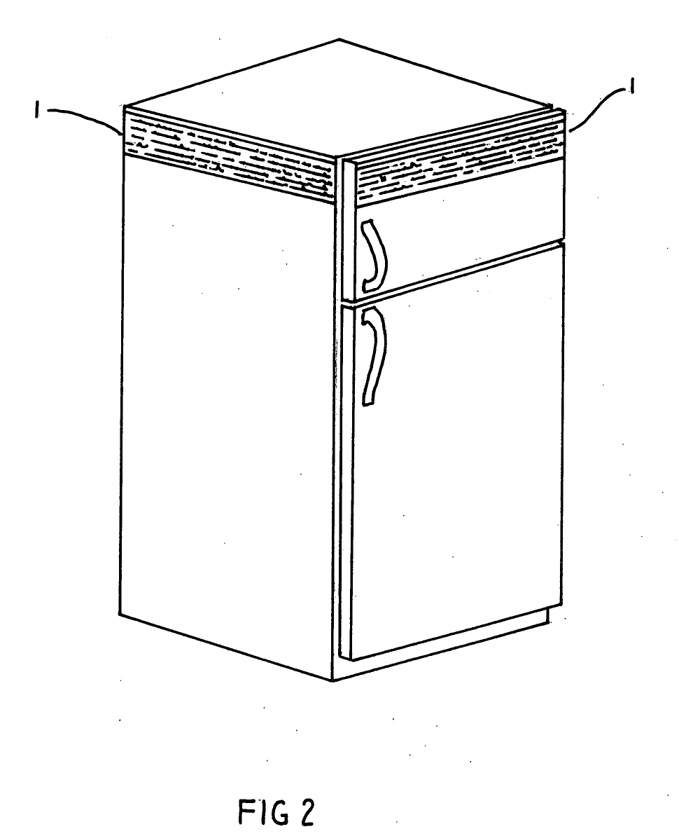

FIG. 2

Is an isometric view of the typical refrigerator with the decorative magnetic strip (1) put in place horizontally across the top of the freezer compartment door and horizontally across the side opposite the hinge side.

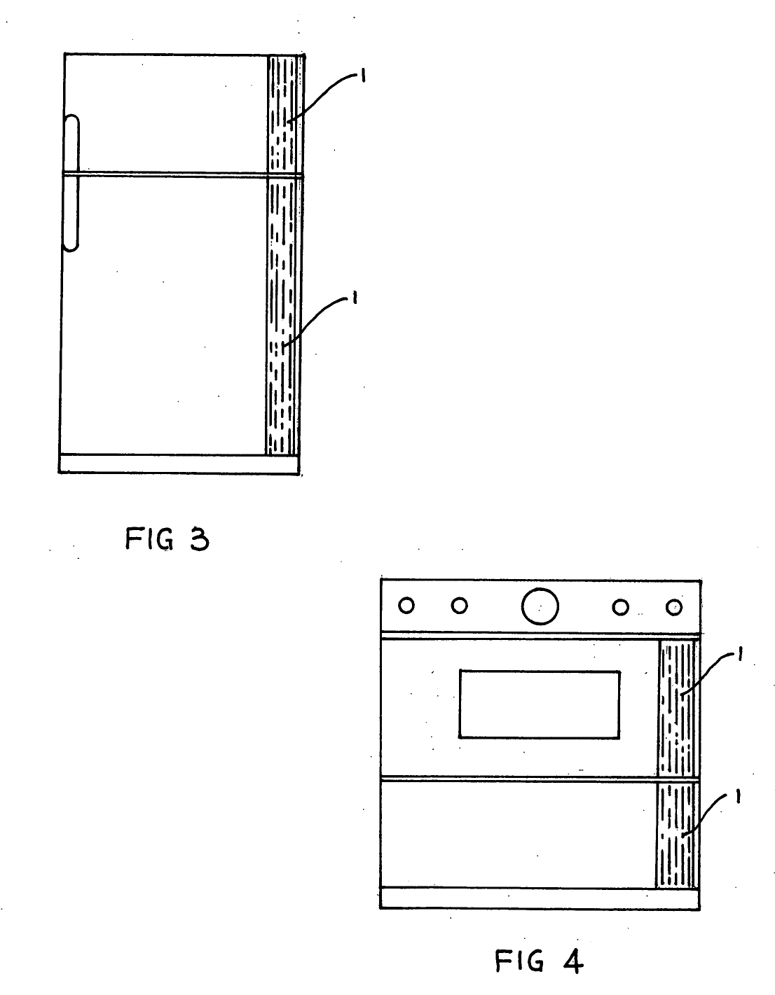

FIG. 3

Is a front view showing a vertical placement of the magnetic decorative strip (1) on are frigerator front.

FIG. 4

Is a front view showing a vertical installation of the magnetic decorative strip (1) on a stove front

FIG. 5

Is a front view showing a horizontal installation of the magnetic decorative strip (1) on a refrigerator front

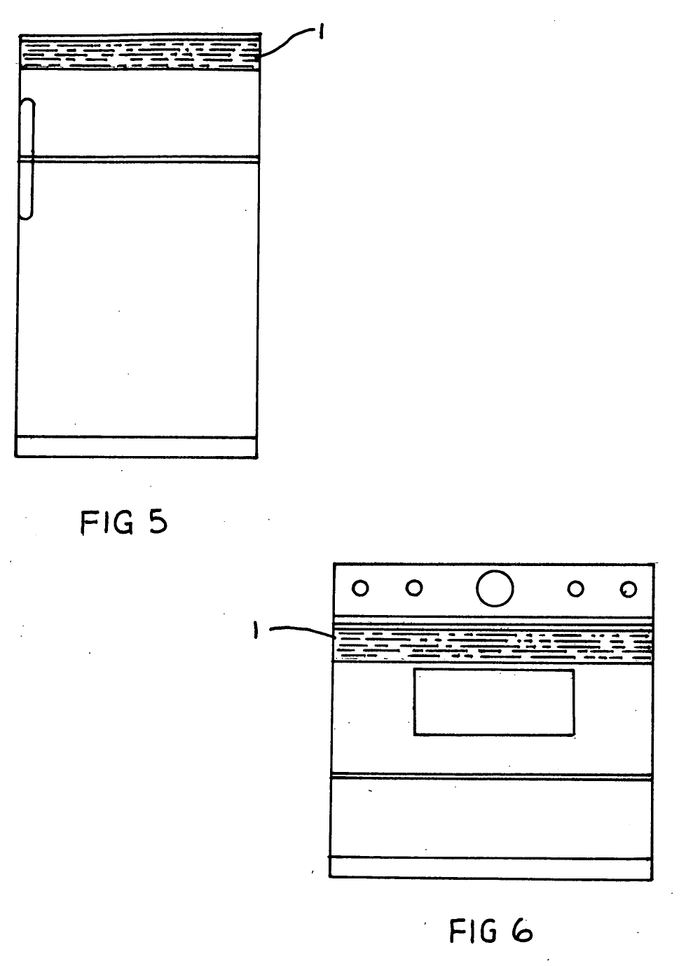

FIG. 6

Is a front view showing a horizontal installation of the magnetic decorative strip (1) on a stove front.

### DETAILED DESCRIPTION OF THE INVENTION

This invention is strip of decorative magnetic strip. The purpose of the magnetic strip is to allow the end user the opportunity to beautify their appliances and help them fit better with the others items and rooms of the home. The base material is very thin magnetic material. The front or outside surface is adorned with variety of decorative patterns. The pattern or covering is applied by painting, printing, embossing, engraving, pressing or veneering. It can be made in varying widths to enable the end user to determine what is best for their application. Because the base material is very thin it is very easily cut to different lengths as application needs require. Also, being magnetic it is easily applied, replaced, removed or relocated.

1. A decorative magnetic border strip used to beautify an otherwise plain surface that will support the function of a magnet:
used to beautify the front and or sides of a refrigerator;
used to beautify the front and/or sides of a stove;
cut into strips from very thin magnetic sheet material;
decorated on the front or outer surface by painting, printing, engraving, stamping or veneering;
